(19) United States
(12) Patent Application Publication
(10) Pub. No.: US 2011/0282953 A1
(43) Pub. Date: Nov. 17, 2011

(54) METHOD AND APPARATUS FOR PROVIDING MESSAGE CONVERSATION BY GROUP IN A MESSAGING SERVICE

(75) Inventors: Kyung-Tak LEE, Yongin-si (KR); Sung-Jin PARK, Hwaseong-si (KR); Seung-Yong LEE, Seoul (KR)

(73) Assignee: Samsung Electronics Co., Ltd.

(21) Appl. No.: 13/109,381

(22) Filed: May 17, 2011

(30) Foreign Application Priority Data
May 17, 2010 (KR) 10-2010-0046088

(51) Int. Cl. G06F 15/16

(52) U.S. Cl. 709/206

(57) ABSTRACT

A method and apparatus for providing a conversation within a conversation group that is conducted by exchanging messages among a plurality of terminals of the same conversation group at a communication terminal supporting a messaging service are provided. In the method a message is received, an active conversation Identifier (ID) is detected from the received message, the active conversation ID identifying a conversation related to the received message and a conversation group including terminals participating in the conversation, and the received message is displayed in a conversation view corresponding to the active conversation ID.

### PRIORITY

This application claims priority under 35 U.S.C. §119(a) to an application filed in the Korean Intellectual Property Office on May 17, 2010 and assigned Serial No. 10-2010-0046088, the entire disclosure of which is incorporated herein by reference.

### BACKGROUND OF THE INVENTION

1. Field of the Invention

The present invention relates generally to a messaging service provided to a mobile communication terminal, and more particularly, to a method and apparatus for, in the presence of a plurality of conversation groups each including a plurality of group members, distinguishing message conversations conducted among group members by group and providing a user with a message conversation of the group to which the user belongs.

2. Description of the Related Art

Short Message Service (SMS), Multimedia Messaging System (MMS), e-mail service, and Instant Messaging (IM) are popular messaging services. Although the messaging services are based on different technologies, from the perspective of user experience, they have many things in common. For example, a text message can be sent by any messaging and messaging services except for SMS enable multimedia content transmission.

Considering that many messaging services offer the same user experience, the Open Mobile Alliance (OMA) has recently standardized a new service called Converged Internet Protocol Messaging (CPM) based on Session Initiation Protocol (SIP) and IP. CPM aims to provide main features of conventional messaging services in a single messaging service. Therefore, a user can experience user services available from all conventional messaging services and exchange messages with all conventional messaging service users, simply with the CPM service.

In the CPM service, a terminal displays received messages for each conversation in the order in which they were received. That is, to help a user to easily grasp a conversation-based message flow, messages for the same conversation subject are displayed in the same conversation view. Such messages as supported by CPM, for example, e-mail or instant messages are exchanged.

However, there may be times when some of the participants of a main conversation may want to form a sub-conversation group within the conversation group and talk in private by transmitting and receiving messages only among the members of the sub-conversation group, in parallel with the main conversation. Further, another independent conversation group may lie under the private conversation group. Therefore, conversations may be conducted in parallel at different levels.

Accordingly, a need exists for a method for effectively managing messages related to different conversations and a method for notifying a user of a correlation between levels of conversations.

### SUMMARY OF THE INVENTION

An aspect of embodiments of the present invention is to address at least the problems and/or disadvantages and to provide at least the advantages described below. Accordingly, an aspect of the present invention is to provide a method and apparatus for displaying conversations that a plurality of conversation groups have, distinguishably by group.

Another aspect of the present invention is to provide a method and apparatus for easily managing conversations that a plurality of conversation groups have.

A further aspect of the present invention is to provide a method and apparatus for distinguishably providing conversations corresponding to a plurality of correlated conversation groups and providing information about the correlations between the conversations.

In accordance with an aspect of the present invention, there is provided a method for providing, a conversation within a conversation group, conducted by exchanging messages among a plurality of terminals of the same conversation group at a communication terminal supporting a messaging service, in which a message is received, an active conversation Identifier (ID) is detected from the received message, the active conversation ID identifying a conversation related to the received message and a conversation group including terminals participating in the conversation, and the received message is displayed additionally in a conversation view corresponding to the active conversation ID.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 illustrates a communication system to which the present invention is applied;

FIG. 2 is a block diagram of a mobile communication terminal according to an embodiment of the present invention;

FIG. 3 illustrates a conversation group creation scenario according to an embodiment of the present invention;

FIG. 4 is a flowchart illustrating a message transmission procedure according to an embodiment of the present invention;

FIGS. 5A and 5B illustrate conversation Identifier (ID) search and generation procedures according to an embodiment of the present invention;

FIG. 6 is a flowchart illustrating a message reception procedure according to an embodiment of the present invention; and

FIGS. 7A to 7D illustrate conversation messages displayed according to an embodiment of the present invention.

Throughout the drawings, the same drawing reference numerals will be understood to refer to the same elements, features and structures.

### DETAILED DESCRIPTION OF EMBODIMENTS OF THE PRESENT INVENTION

Various embodiments of the present invention will be described in detail below with reference to the accompanying drawings. Also, wherever possible, the same reference numbers will be used throughout the drawings and the specification to refer to the same or like parts.

In a system supporting Converged Internet Protocol Messaging (CPM), terminals in a conversation group can conduct a conversation with one another by exchanging messages supported by CPM.

Within the conversation group, some of the conversation members may create a private conversation group and have a private conversation within the private conversation group. Accordingly, the conversation members may create a sub-conversation group within the existing conversation group and exchange messages in the sub-conversation group. Additionally, another independent conversation group may be defined under the sub-conversation group, i.e., a sub-sub-conversation group. Thus, parallel conversations may occur at different levels.

In accordance with an embodiment of the present invention, conversation IDentifiers (IDs) are allocated to an initial conversation group, a sub-conversation group derived from the initial conversation group, and another sub-conversation group derived from the sub-conversation group, so as to distinguishably display and manage conversations conducted in the conversation groups. Further, sub-conversation groups created out of a given conversation group are managed in a tree structure in such a manner that the relationship between a parent conversation group and a child conversation group may be known. In this manner, the correlation between conversations can be provided to a user. Herein, “an initial conversation” refers to a conversation conducted by exchanging messages between members of an initial conversation group and “a private conversation” refers to a conversation conducted by exchanging messages between members of a sub-conversation group.

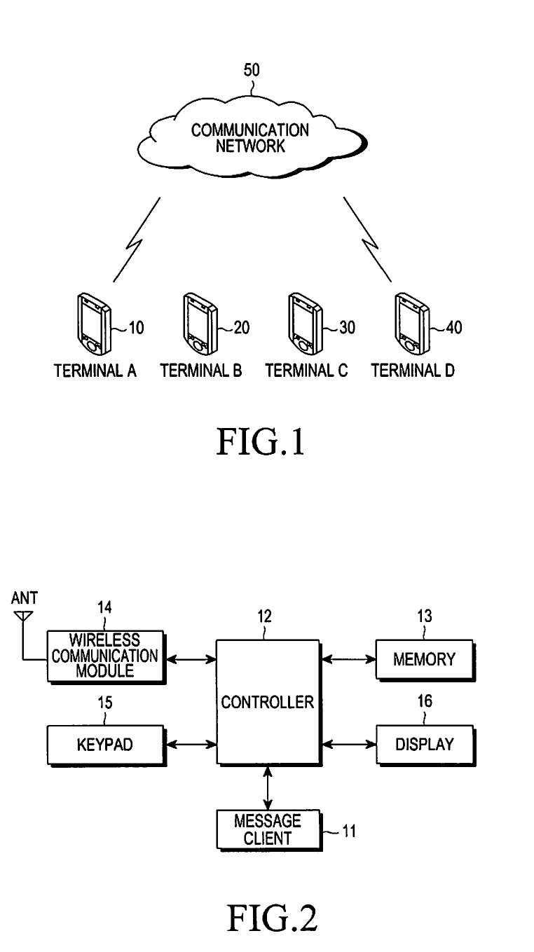

FIG. 1 illustrates a communication system to which the present invention is applied.

Referring to FIG. 1, a plurality of communication terminals 10, 20, 30 and 40 transmit and receive messages over a communication network 50.

The communication network 50 is a network supporting the CPM service, including Base Stations (BSs) needed for wireless communication, exchanges, and messaging servers for transferring messages exchanged between terminals.

The plurality of communication terminals 10, 20, 30 and 40 are mobile communication terminals such as portable phones, smart phones, Personal Digital Assistants (PDAs), etc. While not illustrated, the plurality of communication terminals 10, 20, 30 and 40 may be wired terminals such as PCs. The plurality of communication terminals 10, 20, and 40 support CPM and may be configured, for example, as illustrated in FIG. 2.

FIG. 2 is a block diagram of a mobile communication terminal according to an embodiment of the present invention.

Referring to FIG. 2, a mobile communication terminal includes a message client 11, a controller 12, a display 16, a keypad 15, a wireless communication module 14, and a memory 13.

The message client 11 controls message transmission and reception and manages messages by transmitting commands and data related to message transmission and reception of the mobile communication terminal, referring to information and data received from the controller 12. Specifically, the message client 11 manages the conversation IDs, conversation group information, and associated messages of message conversations according to the present invention. The configuration, actual transmission and reception, management, and display of a message related to CPM are carried out under the control of the message client 11.

The controller 12 provides overall control to the mobile communication terminal. The controller 12 also controls each function block so that operations related to message transmission, reception, and management may be carried out according to commands or data received from the message client 11, and provides information and data related to message transmission, reception, and management to the message client 11. While the message client 11 and the controller 12 are illustrated as separately configured in an embodiment of the present invention, the message client 11 may be incorporated into the controller 12 in another embodiment of the present invention.

The display 16 displays visual information, and data information received from a communication network or stored in the memory 13 on a screen under the control of the controller 12.

The keypad 15 is a user interface through which a user enters data. In another embodiment of the present invention, the keypad 15 may be configured into a touch screen. The keypad 15 is provided with input means corresponding to digit keys 0 to 9, * and # keys, directional keys, and function keys such as menu, OK, call, cancel, power/end, volume, etc., corresponding to a number of functions equipped in the mobile communication terminal and thus provides key input data corresponding to input means pressed by the user. The keypad 15 includes a new message key for generating input data indicating that a message written by a user is a new conversation-related message which is not related to an existing conversation, and a response key for generating input data indicating that the written message is related to the existing conversation in an embodiment of the present invention. The mobile communication terminal may include another user input interface for implementing the functions of the new message key and the response key. For example, an input area corresponding to each function may be displayed on a touch screen and voice commands may be created through the touch screen.

The wireless communication module 14 transmits Radio Frequency (RF) signals to and receives RF signals from a communication network via an antenna, baseband-processes a transmission signal received from the controller 12, transmits a modulated RF signal through the antenna, demodulates an RF signal received through the antenna, baseband-processes the demodulated RF signal, and provides the processed signal to the controller 12, thereby enabling wireless communication and message transmission and reception.

The memory 13 stores programs for processes and control operations of the controller 12, reference data, updatable data to be kept, received multimedia messages, and multimedia messages created according to user input, and provides the stored messages and data to a working memory of the controller 12. In accordance with the present invention, the memory 13 includes a database for storing messages exchanged for a message conversation, the conversation ID of each conversation, information about a conversation group corresponding to the conversation ID, and a tree structure of conversation IDs.

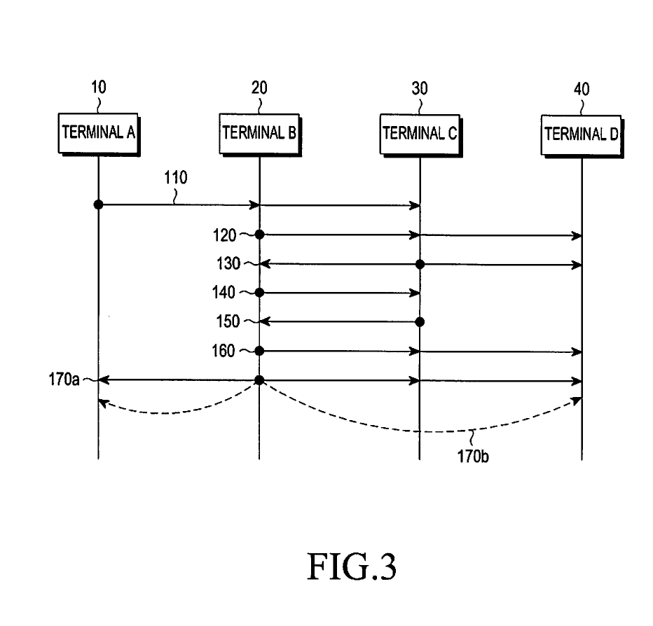

To help understanding of the present invention applied to the system having the configuration illustrated in FIGS. 1 and 2, a scenario of configuring a plurality of sub-conversation groups for private conversations and exchanging messages between members in a sub-conversation group is illustrated in FIG. 3. The scenario of FIG. 3 is based on the assumption that all the members participating in a conversation are the terminals 10, 20, 30 and 40 (terminal A, terminal B, terminal C and terminal D) and an initial conversation group is formed before any individual conversation group is created between terminals, in Step 110.

Referring to FIG. 3, terminal A forms an initial conversation group by initially transmitting a message to terminal B and terminal C in Step 110. The message may carry content corresponding to a specific query.

Upon receipt of the message from terminal A in Step 110, a user of terminal B may read the received message together with the initial conversation group including terminal A, terminal B, and terminal C. The user of terminal B may want to form a private conversation group including terminal C and terminal D separately from the initial conversation group depending on the content of the received message and talk to the other members of the private conversation group. Thus, terminal B may create a new conversation group, i.e. a first sub-conversation group by transmitting a message to terminal C and terminal D and have a private conversation at a first level to the other members of the sub-conversation group before replying to terminal A, in Step 120.

Upon receipt of the first-level message from terminal B in Step 120, terminal C may transmit a message including a reply comment to the received first-level message in Step 130. The message carrying the reply comment is transmitted to terminal B and terminal D of the first sub-conversation group.

After receiving the message from terminal C in Step 130, terminal B may transmit a message requiring an answer from terminal C only. Therefore, terminal B forms a second sub-conversation group by transmitting a message only to terminal C and thus has a private conversation at a second level with terminal C in Step 140.

Upon receipt of the message for the second-level private conversation from terminal B in Step 140, terminal C may transmit a response message carrying a reply to terminal B according to the request of terminal B in Step 150.

After receiving the message from terminal C in Step 150, terminal B ends the second-level private conversation and returns to the first-level private conversation within the first sub-conversation group including terminal B, terminal C and terminal D. Then terminal B transmits a message containing final content to terminal C and terminal D in Step 160.

Subsequently, terminal B configures a message containing content being a response to the message received from terminal A in Step 110 and transmits the configured message to terminal A, terminal C and terminal D in Step 170a. In another example, terminal B may transmit the configured message to terminal A and terminal D except terminal C in Step 170b.

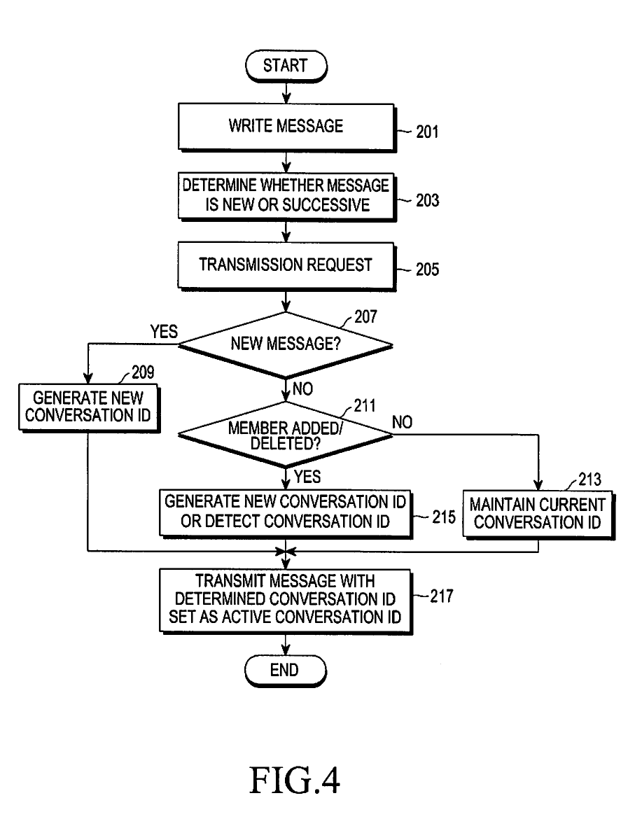

The operation of the mobile communication terminal for transmitting and receiving messages in the scenario of FIG. 3 will be described with reference to FIGS. 4, 5 and 6.

FIG. 4 is a flowchart illustrating a message transmission procedure of the mobile communication terminal, specifically the message client 11 according to an embodiment of the present invention. Before a description of FIG. 4, it is assumed that a private conversation starts among the members of an initial conversation except one or more members and when the excluded one or more members are designated as recipients of a message, the private conversation ends. A unique conversation ID is allocated to each conversation and a conversation group conducting the conversation. Associated mobile communication terminals share a conversation ID.

Referring to FIG. 4, the message client 11 of the mobile communication terminal writes a message to be transmitted, upon request of a user in Step 201. The message includes content to be transmitted and identification information of one or more receiving terminals. The receiving terminals may be selected by the user. If the message is a response to a previously received message, the members of a conversation group corresponding to the message are automatically set as receiving terminals in the message. The received message includes identification information of the members of the associated conversation group. Obviously, one or members of the associated conversation group automatically included in the message may be excluded as receiving terminals from the message and instead, another terminal may be added as a receiving terminal in the message by user selection.

In Step 203, the message client 11 determines whether the written message is a new message or a successive message by checking whether the user has selected a new message key or a response key. A new message is a message for a new initial conversation, not related to any existing conversation. A successive message is a message associated with an existing conversation. That is, upon input of the new message key, the message written in Step 201 is a message for a new initial conversation. Upon input of the response key, the written message is for an existing conversation, successive to a previously received message.

If it is determined that the written message is a new message after the user completes writing the message and inputs a transmission request in Step 205, the message client 11 generates a new conversation ID in Step 207. Then the message client 11 stores conversation group information about an initial conversation group including the receiving terminals and the transmitting terminal and the content of the message, with respect to the new conversation ID in the database. The conversation group information contains a participating member list including the receiving terminals and the transmitting terminal of the written message. In Step 217, the message client 11 transmits a message with the new conversation ID set as an active conversation ID to the communication network 50. Thus the message is delivered to the one or more receiving terminals set in the message. The message delivery is carried out by a messaging server in the communication network 50.

However, if it is determined that the written message is a successive message in Step 207, the message client 11 compares a participating member list of a particular conversation corresponding to a latest received message with the receiving and transmitting terminals of the written message in Step 211. If the list of the receiving and transmitting terminals of the written message is identical to the participating member list of the particular conversation, the message client 11 maintains the conversation ID of the particular conversation and stores the message with respect to the conversation ID in the database in Step 213. In Step 217, the message client 11 transmits a message with the maintained conversation ID set as an active conversation ID to the communication network 50. Thus the message is delivered to the one or more receiving terminals set in the message. The message also contains all parent conversation IDs of the maintained conversation ID.

If the list of the receiving and transmitting terminals of the written message is different from the participating member list of the particular conversation in Step 211, for example, if a new terminal has joined or at least one member of the particular conversation has been excluded, the message client 11 should determine whether the written message is a message for initiating a new private conversation or a message associated with an existing private conversation or an existing initial conversation in Step 215. If the message is for initiating a new private conversation, the message client 11 generates a new conversation ID. If the message is associated with an existing conversation, the message client 11 detects the conversation ID of the existing conversation in the database. Then the message client 11 transmits a message with the new conversation ID or the detected conversation ID set as an active conversation ID to the communication network 50 in Step 217. Thus the message is delivered to one or more receiving terminals set in the message. The message contains all parent conversation IDs of the new or detected conversation ID.

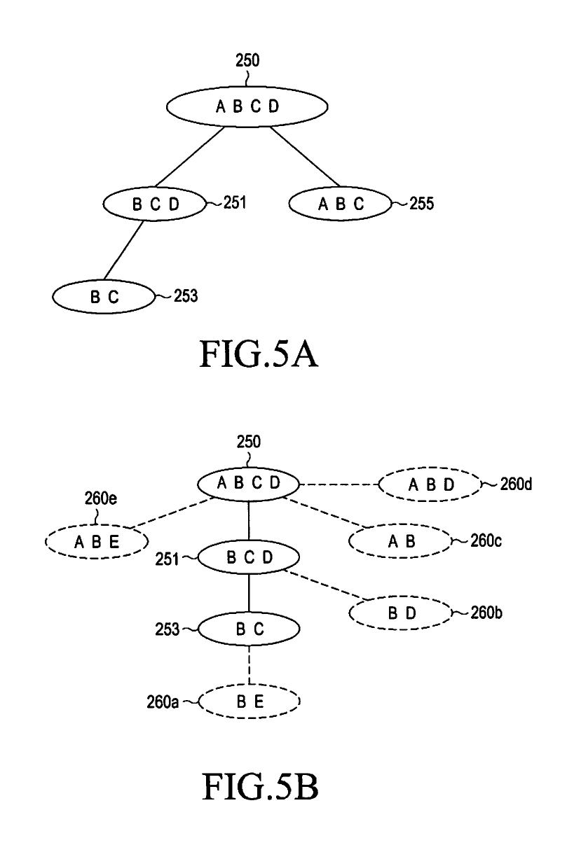

The process of generating a conversation ID for a new private conversation or detecting a conversation ID in a database at the message client 11 in Step 215 will be described in great detail with reference to FIGS. 5A and 5B. In Step 211, the participating terminals of the particular conversation corresponding to the latest received message may not match the transmitting and receiving terminals set in the written message in the following three cases.

In the first case, at least one of the participating terminals of the particular conversation is excluded. In the second case, a new terminal is added to the participating terminals of the particular conversation. In the third case, at least one of the participating terminals of the particular conversation is excluded and a new terminal is added to the participating terminals of the particular conversation.

If at least one terminal is excluded from the participating terminals of the particular conversation without a new terminal joining the participating terminals as in the first case and there is no conversation group having the participating member list of the transmitting and receiving terminals included in the written message, the message client 11 determines that a new private conversation starts, generates a conversation ID for the new private conversation, and defines the tree layers of the conversation ID of an associated initial conversation and the new conversation ID. The conversation ID of the initial conversation is a parent conversation ID and the new conversation ID is a child conversation ID. In the presence of a conversation group with the participating member list including only the transmitting and receiving terminals set in the written message, the message client 11 uses the conversation ID of the conversation group.

For example, if the particular conversation is an initial conversation, the participating terminals of the initial conversation are terminal A, terminal B, terminal C and terminal D, and then terminal A is excluded from the participating terminals, sub-conversation group A including terminal B, terminal C and terminal D is newly created and a private conversation at a first level starts in sub-conversation group A.

If the particular conversation is the first-level private conversation and terminal D is not set in the written message, sub-conversation group A-1 with terminal B and terminal C may be newly created. Sub-conversation group A-1 is a child group of sub-conversation group A. Thus a private conversation at a second level starts in sub-conversation group A-1. The conversation ID of sub-conversation group A and the conversation ID of initial conversation group A are the parent conversation IDs of sub-conversation group A-1.

The foregoing examples are illustrated in FIG. 5A. Referring to FIG. 5A, an initial conversation group 250 (initial conversation group A) with terminals A, B, C and D as participating members, sub-conversation groups 251 and 255 (sub-conversation group A and sub-conversation group B) as direct child groups of the initial conversation group A, and a sub-conversation group 253 (sub-conversation group A-1) as a child group of the sub-conversation group A are illustrated in a tree structure. The members of sub-conversation group A are terminals B, C and D, the members of sub-conversation group B are terminals A, B and C, and the members of sub-conversation group A-1 are terminals B and C.

If a new terminal joins the particular conversation group without any excluded member as in the second case and there is no conversation group having the participating member list of the transmitting and receiving terminals set in the written message, the most similar sub-conversation group hierarchically close to the active conversation group is detected and the conversation ID of the detected sub-conversation group is used.

The case where a new terminal is only added to the particular conversation group without any excluded terminal may further be branched into two cases. First of all, as a lower-layer private conversation ends, all participating terminals excluded from a higher-layer initial conversation return to the initial conversation. In addition, a new terminal may join the particular conversation, thus increasing the number of members in the participating member list of the particular conversation. If the particular conversation is a private conversation, a participating terminal excluded from the very start of the private conversation may join the private conversation.

Therefore, if the current particular conversation does not have a parent conversation ID, the message client 11 uses the conversation ID of the particular conversation. If the particular conversation has one or more parent conversations, the message client 11 searches for a private conversation with the most similar participating member list, hierarchically close to the active conversation, among the parent conversations.

Referring to FIGS. 4 and 5A, it is assumed that the latest received message is for a second-level private conversation of sub-conversation group A-1 and the transmitting terminal is terminal B. If the written message includes terminals C and D as receiving terminals, the message client 11 detects the conversation ID of sub-conversation group A in Step 215. In another example, if terminals C, D, and E are set as the receiving terminals in the message, the message client 11 also uses the conversation ID of sub-conversation group A.

If the receiving terminals set in the written message are terminals A, C, D and E, the message client 11 uses the conversation ID of initial conversation group A. If the receiving terminals set in the written message are terminals A, C and E, the message client 11 uses the conversation ID of sub-conversation group B.

As in the third case, if at least one terminal is excluded from and a new terminal is added to the participating terminals of the particular conversation corresponding to the latest received message and there is no conversation group with the resulting terminal list, a sub-conversation group having a similar participating member list including the new terminal is detected. Then at least one terminal is excluded from the detected sub-conversation group, thus creating a new sub-conversation group. In the presence of a conversation group with the participating member list of the transmitting and receiving terminals set in the written message, the conversation ID of this conversation group is used.

If the particular conversation is an initial conversation with no parent conversation, the message client 11 creates a new sub-conversation group under the initial conversation group by excluding at least one of the members of the initial conversation and allocates a new conversation ID to the new sub-conversation group, thus initiating a new private conversation. However, if the particular conversation has one or more parent conversations, the message client 11 detects a sub-conversation group with a similar participating member list including the added terminal, hierarchically close to the active conversation group in the tree structure, among the parent conversations. Then a new sub-conversation group is created under the detected sub-conversation group by excluding at least one terminal from the detected sub-conversation group. In the absence of a detected sub-conversation group, the message client 11 creates a new sub-conversation group by excluding at least one terminal from the sub-conversation group corresponding to the particular conversation and adds a new terminal to the created sub-conversation group.

The foregoing examples will be described with reference to FIGS. 4 and 5B. Referring to FIG. 5B, initial conversation group A (initial conversation group 250), sub-conversation group A (sub-conversation groups 251) as the direct child group of initial conversation group A, and sub-conversation group A-1 (sub-conversation group 253) as the child group of sub-conversation group A form a tree structure. With respect to the conversation relationship in the tree structure, it is assumed that the particular conversation corresponding to the latest received message is a private conversation in sub-conversation group A-1 and the transmitting terminal of the written message is terminal B. Examples of sub-conversation groups that can be newly created according to receiving terminals set in the message written in Step 201 of FIG. 4 are denoted by reference numerals 260a to 260e, in FIG. 5B.

If the receiving terminal set in the written message is terminal E, this means that terminal E is added to and terminal C is excluded from the members of the particular conversation in case of sub-conversation group A-1. Because sub-conversation group A-1 has parent conversation groups, a parent conversation group including terminal E should be detected. However, there is no parent conversation group with terminal E. Thus the message client 11 creates a sub-conversation group 260a (sub-conversation group A-1-1) by excluding terminal C from sub-conversation group A-1, allocates a new conversation ID to sub-conversation group A-1-1, and adds terminal E to sub-conversation group A-1-1.

In another example, if the receiving terminal set in the written message is terminal D, this means that terminal D is added to and terminal C is excluded from the members of the particular conversation in sub-conversation 253 (sub-conversation group group A-1). Because sub-conversation group A-1 has parent conversation groups, a parent conversation group including terminal D should be detected. Thus, sub-conversation group A is detected from among the higher-layer parent conversation groups. Then the message client 11 creates a sub-conversation group 260b (sub-conversation group A-2) by excluding terminal C from sub-conversation group A and allocates a new conversation ID to sub-conversation group A-2 in Step 215.

In another example, if the receiving terminal set in the written message is terminal A, this means that terminal A is added to and terminal C is excluded from the members of the particular conversation in case of sub-conversation group A-1. Because sub-conversation group A-1 has parent conversation groups, a parent conversation group including terminal A should be detected. Thus, initial conversation group A with terminal A is detected from among the higher-layer parent conversation groups. Then the message client 11 creates a sub-conversation group 260c (sub-conversation group B) by excluding terminals C and D from initial conversation group A and allocates a new conversation ID to sub-conversation group B in Step 215.

In another example, if the receiving terminals set in the written message are terminals A and D, this means that terminals A and D are added to and terminal C is excluded from the members of the particular conversation in case of sub-conversation group A-1. Because sub-conversation group A-1 has parent conversation groups, a parent conversation group including terminals A and D should be detected. Thus, initial conversation group A is detected from among the higher-layer parent conversation groups. Then the message client 11 creates a sub-conversation group 260d (sub-conversation group C) by excluding terminal C from initial conversation group A and allocates a new conversation ID to sub-conversation group C in Step 215.

In a further example, if the receiving terminals set in the written message are terminals A and E, this means that terminals A and E are added to and terminal C is excluded from the members of the particular conversation in case of sub-conversation group A-1. Because sub-conversation group A-1 has parent conversation groups, a parent conversation group including terminals A and E should be detected. Thus, initial conversation group A is detected from among the higher-layer parent conversation groups. Then the message client 11 creates a sub-conversation group 260e (sub-conversation group D) by excluding terminals C and D from initial conversation group A, allocates a new conversation ID to sub-conversation group D, and adds terminal E to sub-conversation group D in Step 215.

An active conversation ID determined in the above manner and associated parent conversation IDs are included in a message according to the present invention. Accordingly, the message may contain a new header field carrying the active conversation ID and the parent conversation IDs.

In accordance with an embodiment of the present invention, a conversation ID “CPM-Conversation-ID” may be defined in conformance to the CPM standard and included in a message as follows, by way of example.

According to the CPM standard, the conversation ID “CPM-Conversation-ID” may be defined according to the Augmented Backus-Naur Form (ABNF) rule described as Table 1.

TABLE 1

```
    CPM-Conversation-ID=”CPM-Conversation-ID” HCOLON
conversationid
    conversationid=word
(where “word” is defined in IETF RFC 3261 as follows:
  word=1*(alphanum/”-”/”.”/”!”/”%”/”*”/”_”/”+”/
”‘”/”’”/”□”/”(”/”)”/”<”/”>”/”:”/”□”/DQUOTE/”/”/
”[”/”]”/”?”/”{”/”}”)
```

For example, the conversation ID “CPM-Conversation-ID” generated according to the rule of Table 1 may be given as

TABLE 2
CPM-Conversation-ID:f81d4fae-7dec-11d0-a765-00a0c91e6bf6

According to an embodiment of the present invention, “CPM-Parent-Conversation-ID” may have the following syntax.

```
TABLE 3
    CPM-Parent-Conversation-ID=“CPM-Parent-Conversation-ID”
HCOLON conversationid*(COMMA conversationid)
    Conversationid=word
```

If “CPM-Conversation-ID” identifies a particular CPM conversation, “CPM-Parent-Conversation-ID” identifies one or more parent CPM conversations of the current CPM conversation. The parent CPM conversations of the current CPM conversation may contain other parent CPM conversations above the direct parent CPM conversation of the current CPM conversation. For instance, a parent CPM conversation of the current CPM conversation may be a child CPM conversation of another CPM conversation. Here, “CPM-Parent-Conversation-ID” values are arranged in the order of closeness to the current CPM conversation. That is, the ID “CPM-Parent-Conversation-ID” of the direct parent conversation of “CPM-Conversation-ID” is followed by a parent conversation ID of “CPM-Parent-Conversation-ID”.

An example of this case is illustrated in Table 4.

```
TABLE 4
    CPM-Conversation-ID:f81d4fae-7dec-11d0-a765-00a0c91e6bf6
    CPM-Parent-Conversation-ID:
ghijkl-5678-9012-34gh-ijk01234567,
abcdef-1234-5678-90ab-cdef01234567
```

As described above, definition of conversation IDs will be described, for example, in the scenario illustrated in FIG. 3.

Let an initial conversation and a private conversation be denoted by “Init_Conv” and “Priv_Conv”, respectively. Then a conversation ID defined in each step of FIG. 3 is given as follows.

```
TABLE 5
  Init_Conv=initially formed by terminal A, terminal B and terminal C
and then extended to terminal D
  Priv_Conv_1=ID of first-level private conversation formed by
terminal B, terminal C and terminal D except for terminal A
  Priv_Conv_2=ID of second-level private conversation formed
by terminal B and terminal C except for terminal A and terminal D
  Priv_Conv_1b=ID of first-level private conversation formed by
terminal A, terminal B and terminal D except for terminal C
  Step 110: CPM-Conversation-ID: Init_Conv
  Step 120: CPM-Conversation-ID: Priv_Conv_1
              CPM-Parent-Conversation-ID: Init_Conv
  Step 130: CPM-Conversation-ID: Priv_Conv_1
              CPM-Parent-Conversation-ID: Init_Conv
  Step 140: CPM-Conversation-ID: Priv_Conv_2
              CPM-Parent-Conversation-ID: Priv_Conv_1, Init_Conv
  Step 150: CPM-Conversation-ID: Priv_Conv_2
              CPM-Parent-Conversation-ID: Priv_Conv_1, Init_Conv
  Step 160: CPM-Conversation-ID: Priv_Conv_1
              CPM-Parent-Conversation-ID: Init_Conv
  Step 170a: CPM-Conversation-ID: Init_Conv
  Step 170b: CPM-Conversation-ID: Priv_Conv_1b
              CPM-Parent-Conversation-ID: Init_Conv
```

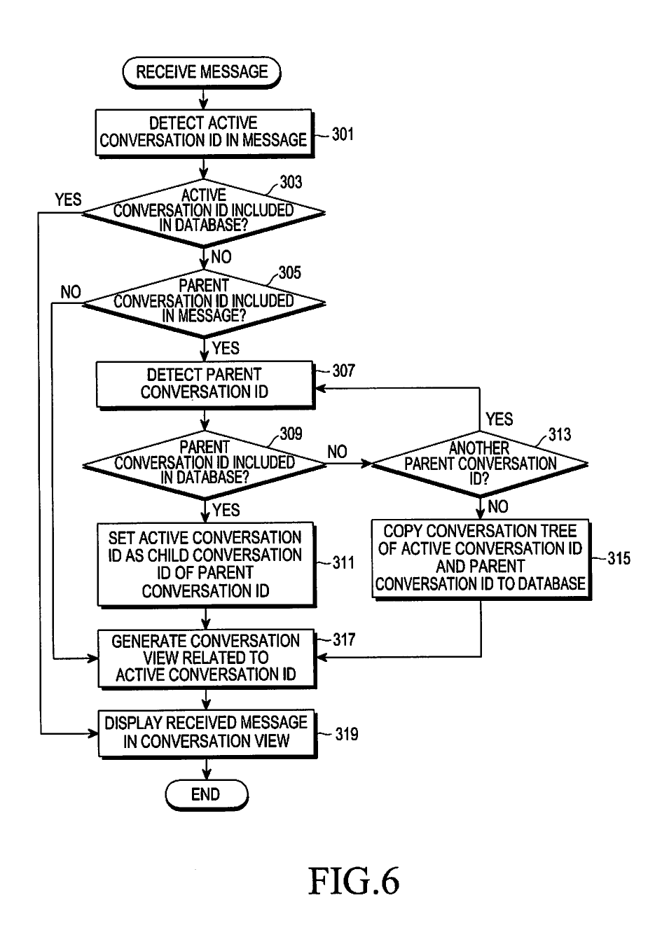

FIG. 6 is a flowchart illustrating an operation for, upon receipt of a message including a conversation ID and a parent conversation ID determined in the above manner, processing the received message at the mobile communication terminal.

Referring to FIG. 6, upon receipt of a message, the message client 11 detects an active conversation ID from the received message in Step 301 and determines whether the active conversation ID exists in the database in Step 303. In the presence of the active conversation ID in the database, the message client 11 additionally displays the received message in a conversation view associated with the active conversation ID in Step 319. A conversation view is a display form for displaying the content of a message in a way that distinguishes the corresponding conversation. The display form may be a window frame, a color, a font, etc. set for each conversation. The form of a conversation view may vary with user settings.

In the absence of the active conversation ID in the database, the message client 11 determines whether the received message includes a parent conversation ID in Step 305. The absence of the active conversation ID in the database implies that the received message is for initiating a new conversation. The new conversation may be an initial conversation or a new private conversation. It is determined whether the new conversation is an initial conversation or a new private conversation according to the inclusion or non-inclusion of a parent conversation ID in the received message. If a parent conversation ID is not included in the received message, the received message is for initiating a new initial conversation. On the contrary, if a parent conversation ID is included in the received message, the received message is for initiating a new private conversation.

In the absence of a parent conversation ID in the received message, the message client 11 generates a conversation view related to the active conversation ID in Step 317 and adds the received message to the conversation view in Step 319. Then the message client 11 stores the active conversation ID as a conversation ID for the new initial conversation and stores the received message and identification information of transmitting and receiving terminals set in the received message with respect to the active conversation ID in the database.

In the presence of a parent conversation ID in the received message, the message client 11 detects the parent conversation ID from the received message in Step 307 and determines whether the parent conversation ID exists in the database in Step 309. In the presence of the parent conversation ID in the database, the message client 11 sets the active conversation ID as a child conversation ID of the parent conversation ID, thus updating a conversation tree in Step 311. Then steps 317 and 319 are performed. The message client 11 stores the received message and the identification information of the transmitting and receiving terminals set in the received message with respect to the active conversation ID in the database. If the received message contains an ID other than the parent conversation ID, such as a parent conversation ID of the parent conversation ID, the ID is also stored according to the tree structure.

In the absence of the parent conversation ID in the database in Step 309, the message client 11 determines whether another parent conversation ID is included in the received message I Step 313. In the absence of another parent conversation ID in the received message, the message client 11 copies the conversation tree of the active conversation ID and the parent conversation ID included in the received message to the database in Step 315 and then performs steps 317 and 319. Then the message client 11 stores the received message and the identification information of the transmitting and receiving terminals set in the received message with respect to the active conversation ID in the database.

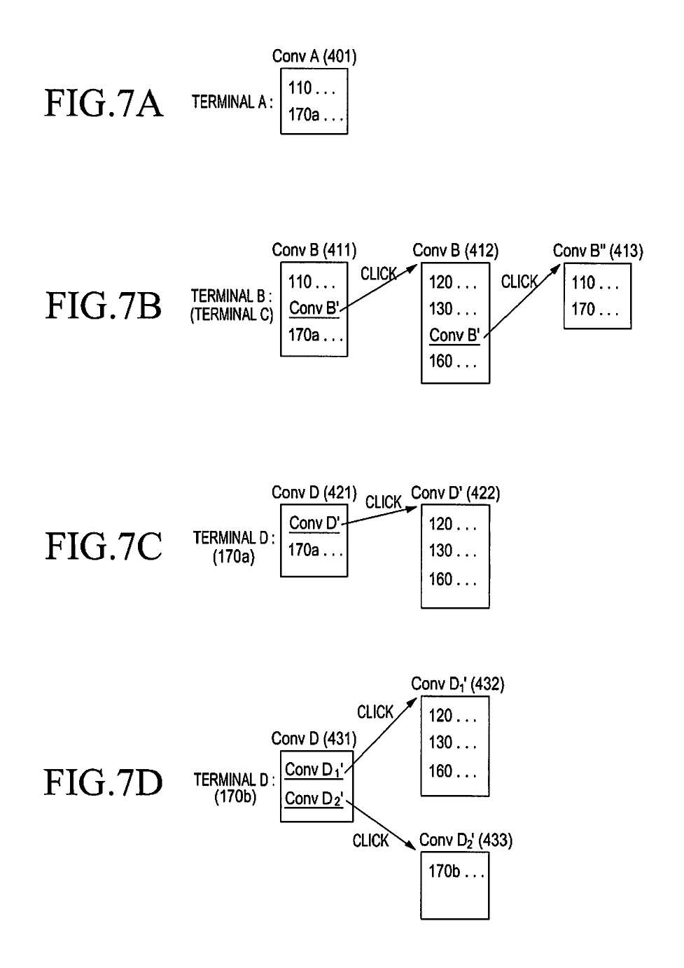

While description above includes that the message adds to the conversation view in Step 319, it may be further contemplated that a direct child conversation is hyperlinked for the message within a parent conversation view. When the hyperlink is selected, the message is displayed in a new conversation view. There may also be a child conversation in the new conversation view. Here, the child conversation may also be displayed using a hyperlink. Examples of this are illustrated in FIGS. 7A to 7D.

The mobile communication terminal that transmits and receives messages in the above-described procedure may operate as follows in the scenario of FIG. 3.

In Step 110, terminal A forms an initial conversation group by initially transmitting a message to terminals B and C. The message is for a new initial conversation. Thus, the message client 11 of terminal A generates a new conversation ID “Init_Conv”, sets the new conversation ID “Init_Conv” as an active conversation ID in the message, and transmits the message to terminals B and C.

Upon receipt of the message from terminal A, terminals B and C detect the active conversation ID “Init_Conv” from the received message and search for the active conversation ID “Init_Conv” in their database. Because the message is for a new conversation, the conversation ID “Init_Conv” does not exist in the database of terminals B and C. The received message does not include a parent conversation ID either. Accordingly, terminals B and C generate new conversation views corresponding to the conversation ID “Init_Conv”, and display the received message in the conversation views.

The user of terminal B may read the message together with the initial conversation group of terminals A, B and C. Apart from the initial conversation group, the user of terminal B may want to form a private conversation group with terminals C and D according to the content of the received message and talk to users of terminals C and D. That is, the user of terminal B may newly create a first sub-conversation group and conduct a private conversation with the other members of the first sub-conversation group.

Thus, the user of terminal B writes a message after selecting the response key in the keypad of terminal B and the message client 11 of terminal B determines the message to be a successive message to the received message. Then the user of terminal B may exclude terminal A from receiving terminals and add terminal D as a new receiving terminal. Thus the message client 11 of terminal B starts a new private conversation and generates a first child conversation ID “Priv_Conv_1” dependent on an initial conversation ID “Int_Conv” received from terminal A. Terminal B includes the first child conversation ID “Priv_Conv_1” as an active conversation ID and the conversation ID “Int_Conv” as a parent conversation ID in the written message and transmits the message to terminal C and terminal D in Step 120.

Upon receipt of the message from terminal B, terminals C and D detect the active conversation ID “Priv_Conv_1” in the received message and search for “Priv_Conv_1” in their database in Step 120. Because “Priv_Conv_1” is for a new private conversation, it does not exist in the database. Therefore, the message clients 11 of terminals C and D detect the parent conversation ID “Int_Conv” in the received message and searches for “Int_Conv” in their database.

Because the message client 11 of terminal C received the message from terminal A in Step 110, the message client 11 can detect the parent conversation ID “Int_Conv” in its database. The message client 11 of terminal C adds the conversation ID “Priv_Conv_1” as a child conversation ID of the detected conversation ID “Int_Conv”, generates a new conversation view corresponding to the conversation ID “Priv_Conv_1”, and displays the content of the message in the new conversation view.

However, because terminal D has never received a message related to the parent conversation ID “Int_Conv”, it cannot find “Int_Conv” in its database. Therefore, the message client 11 of terminal D copies the tree structure of the parent conversation ID “Int_Conv” and the child conversation ID “Priv_Conv_1”, adds the tree structure as a new conversation tree to the database, generates a new conversation view corresponding to the conversation ID “Priv_Conv_1”, and displays the content of the message in the new conversation view.

After receiving the message related to the first-level private conversation from terminal B in Step 120, the user of terminal C may transmit a message including a reply comment to the received message in Step 130. If the user of terminal C neither excludes a terminal nor adds a terminal during writing a successive message to the received message, the active conversation ID “Priv_Conv_1” set in the received message is maintained as an active conversation ID and the parent conversation ID is also maintained in the successive message. The message with the reply comment is transmitted to terminals B and D of the first sub-conversation group in Step 130.

Upon receipt of the message from terminal C in Step 130, terminals B and D extract the active conversation ID “Priv_Conv_1” from the received message, detect the same conversation ID in their database, and display the received message in the associated conversation views.

The user of terminal B may transmit a message requiring a reply only from terminal C according to the content of the message received from terminal C. Hence, the user of terminal B inputs the response key during writing a message, and excludes terminal D from receiving terminals, thus forming a second sub-conversation group including terminals B and C. A private conversation is conducted at a second level between terminals B and C.

The message client 11 of terminal B generates an active conversation ID “Priv_Conv_2” of the second-level private conversation as a child conversation ID of the conversation ID “Priv_Conv_1” and transmits a message including the active conversation ID “Priv_Conv_1” and the parent conversation IDs “Priv_Conv_1” and “Init_Conv” to terminal C in Step 140.

Upon receipt of the message from terminal B in Step 140, terminal C extracts the active conversation ID “Priv_Conv_2” from the received messages and searches for “Priv_Conv_2” in its database. However, because the active conversation ID “Priv_Conv_2” is a new conversation ID, the conversation ID “Priv_Conv_2” does not exist in the database. Yet, the parent conversation IDs “Priv_Conv_1” and “Init_Conv” are included in the database and thus the message client 11 of terminal C adds the conversation ID “Priv_Conv_2” as a child conversation ID dependent on the conversation ID “Priv_Conv_1” to the database. The message client 11 of terminal C displays a new conversation view corresponding to the conversation ID “Priv_Conv_2” and displays the content of the message in the new conversation view.

Terminal C, which has received a message for a second-level private conversation in Step 140, may transmit a response message carrying a replay to terminal B in Step 150. The message is for the second-level private conversation and thus includes the active conversation ID “Priv_Conv_2” and the parent conversation IDs “Priv_Conv_1” and “Init_Conv”.

Upon receipt of the message from terminal C in Step 150, terminal B displays the content of the message in a conversation view corresponding to the active conversation ID “Priv_Conv_2” included in the received message.

After receiving the message from terminal C, the user of terminal B may end the second-level conversation and return to the first-level private conversation of the first sub-conversation group including terminals B, C and D. Here, a message written by the user of terminal B is a successive message. From the perspective of the members of the second-level private conversation, terminal D is added but no terminal is excluded.

That is, the user of terminal B writes a message and adds terminal D as a receiving terminal in the message. Then the message client 11 of terminal B searches for the parent conversations of the current active conversation, that is, the second-level private conversation. The parent conversations of the second-level private conversation are the first-level private conversation of terminals B, C and D and the second-level initial conversation of terminals A, B and C. The message client 11 of terminal B compares the members of the second-level private conversation added with terminal D with the members of the parent conversations and detects a conversation having the most similar participating member list and having a level closest to the active conversation. Since as a result of the comparison, the participating member list of the first-level conversation is identical to the participating member list including the members of the second-level private conversation and terminal D, the message client 11 of terminal B selects the first-level private conversation. Therefore, the written message includes an active conversation ID set to “Priv_Conv_1” and a parent conversation ID set to “Init_Conv” and is transmitted to terminal C and terminal D in Step 160.

Terminals C and D that receive the message from terminal B in Step 160 have conducted a conversation corresponding to the active conversation ID “Priv_Conv_1” in Step 120. Therefore, the active conversation ID “Priv_Conv_1” exists in their database. Thus, terminals C and D display the content of the received message in the conversation views corresponding to the conversation ID “Priv_Conv_1”.

The user of terminal B may then want to generate a message carrying content as a response to the message received from terminal A in Step 110 and to transmit the message to terminals A, C and D in Step 170a. Thus, the user of terminal B writes a message including terminal A added as a receiving terminal without exclusion of any existing receiving terminal set in the message received in Step 160. The message client 11 of terminal B detects the conversation ID “Init_Conv” for use in the message from among the parent conversation IDs of the conversation ID “Priv_Conv_1”. This is because terminals A, B, C and D are associated with the current written message and the list of these terminals is most approximate to the participating member list of the initial conversation.

Terminal B includes the detected conversation ID “Init_Conv” as an active conversation ID in the current message and transmits the current message to terminals A, C and D in Step 170a. Since the active conversation ID “Init_Conv” is the initial conversation ID, there is no parent conversation ID set in the message.

Upon receipt of the message from terminal B, terminals A and C preserve the conversation ID “Init_Conv” in their database and thus display the content of the message in the conversation views corresponding to the conversation ID “Init_Conv”.

Because terminal D has not received the message in Step 110, it has never participated in the conversation corresponding to the conversation ID “Init_Conv”. However, the message received from terminal B in Step 120 includes the conversation ID “Init_Conv” as a parent conversation ID and thus the conversation ID “Init_Conv” exists in the database. Therefore, the message client 11 of terminal D detects the conversation ID “Init_Conv” from the database and displays the content of the message in a conversation view corresponding to the conversation ID “Init_Conv”.

In another example, the user of terminal B may want to configure a message carrying content as a response to the message received from terminal A in Step 110 and to transmit the message to terminals A and D except for terminal C in Step 170b. Hence, terminal C is excluded from the receiving terminals of the message received in Step 160 and terminal A is added to the resulting receiving terminals in the message.

The message client 11 of terminal B adds terminal A to the members corresponding to the conversation ID “Priv_Conv_1”, terminals B, C and D, and searches for a conversation with a similar participating member list. The initial conversation is detected as the most similar conversation close to the active conversation. Then terminal C is excluded from the members of the initial conversation. Since there is no conversation with a participating member list excluding terminal C, that is, a participating member list of terminals A, B and D, the message client 11 of terminal B generates a new conversation ID “Priv_Conv_1b” as a child conversation ID of the conversation ID “Init_Conv”. Thus a new first-level private conversation starts. The message client 11 of terminal B transmits a message with the active conversation ID “Priv_Conv_1b” and the parent conversation ID “Init_Conv” to terminals A and D.

Upon receipt of the message from terminal B in Step 170b, terminals A and D add the conversation ID “Priv_Conv_1b” as a child conversation ID of the parent conversation ID “Init_Conv” because they do not store the active conversation ID “Priv_Conv_1b”. Then terminals A and D generate new conversation views corresponding to the conversation ID “Priv_Conv_1b” and display the content of the message in the new conversation views.

FIGS. 7A to 7D illustrate conversation views displayed according to the scenario of FIG. 3. In FIGS. 7A to 7D, a hyperlink related to a direct child conversation is included in a parent conversation view. Upon selection of the hyperlink, conversation messages of the direct child conversation are displayed in a new conversation view. There may be a child conversation in the new conversation view. The child conversation may also be hyperlinked.

FIG. 7A illustrates a conversation view 401, Conv A displayed on terminal A, when Step 170a is performed in the scenario. Since terminal A receives only the same-level conversations, that is, only messages related to an initial conversation in steps 110 and 170a, the conversation view 401, Conv A does not include any hyperlink to a child conversation.

FIG. 7B illustrates a conversation view 411, Conv B, a conversation view 412, Conv B′, and a conversation view 413, Conv B″ displayed on terminals B and C, when Step 170a is performed in the scenario. The conversation view 411, Conv B displays messages related to the initial conversation transmitted and received in steps 110 and 170a and a hyperlink “Conv B′” corresponding to a first-level private conversation. Upon selection of the hyperlink “Conv B′”, the conversation view 412, Conv B′ is displayed. Messages related to the first-level private conversation transmitted and received in steps 120, 130 and 160 and a hyperlink “Conv B″” corresponding to a second-level private conversation are included in the conversation view 412, Conv B′. Upon selection of the hyperlink “Conv B″”, the conversation view 413, Conv B″ is displayed and messages related to the second-level private conversation transmitted and received in steps 140 and 150 are included in the conversation view 413, Conv B″.

FIG. 7C illustrates a conversation view 421, Conv D and a conversation view 422, Conv D′ displayed on terminal D, when Step 170a is performed in the scenario. The conversation view 421, Conv D displays a message related to the initial conversation received in Step 170a and a hyperlink “Conv D′” corresponding to the first-level private conversation. Upon selection of the hyperlink “Conv D′”, the conversation view 422, Conv D′ is displayed. Messages related to the first-level private conversation transmitted and received in steps 120, 130 and 160 are included in the conversation view 422, Conv D′.

FIG. 7D illustrates a conversation view 431, Conv D, a conversation view 432, Conv D1′, and a conversation view 433, Conv D2′ displayed on terminal D, when Step 170b is performed in the scenario. The conversation view 431, Conv D is for the initial conversation. While terminal D does not transmit and receive a message related to the initial conversation in the scenario, the direct parent conversation of private conversations related to messages transmitted and received in steps 120, 130, 160 and 170b is the initial conversation. Thus the conversation view 431, Conv D may be displayed to display hyperlinks to the private conversations. Hence, hyperlinks “Conv D1′” and “Conv D2′” corresponding to first-level private conversations are included in the conversation view 431, Conv D.

Upon selection of the hyperlink “Conv D1′”, the conversation view 432, Conv D1′ is displayed and messages related to the first level-private conversation transmitted and received in steps 120, 130 and 160 are included in the conversation view 432, Conv D1. Upon selection of the hyperlink “Conv DT′”, the conversation view 433, Conv D2′ is displayed and a message related to the first level-private conversation received in Step 170b is included in the conversation view 433, Conv D2.

The detailed description of the embodiments of the present invention has been given to enable those skilled in the art to implement and practice the invention. Although certain embodiments the present invention have been described above, those skilled in the art will appreciate that various modifications and variations can be made in the present invention without departing from the spirit or scope of the invention described in the appended claims. For example, a plurality of private conversations related to an initial conversation may be displayed in different colors designated for the private conversations within the same window frame. Accordingly, the scope of the invention should be determined by the appended claims.

What is claimed is:

1. A method for providing, a conversation within a conversation group, conducted by exchanging messages among a plurality of terminals of the same conversation group at a communication terminal supporting a messaging service, the method comprising:
receiving a message, by a communication terminal;
detecting an active conversation Identifier (ID) from the received message, the active conversation ID identifying a conversation related to the received message and a conversation group including terminals participating in the conversation; and
displaying the received message in a conversation view corresponding to the active conversation ID.

2. The method of claim 1, wherein displaying the received message comprises displaying the received message in the conversation view corresponding to the active conversation ID, if a conversation ID identical to the active conversation ID is included in a database that stores conversation IDs allocated to respective conversations and a correlation between the conversation IDs in a tree structure.

3. The method of claim 2, further comprising generating a new conversation view corresponding to the active conversation ID and displaying the received message in the new conversation view, if the conversation ID identical to the active conversation ID is not included in the database and the received message does not include a parent conversation ID.

4. The method of claim 2, wherein if the conversation ID identical to the active conversation ID is not included in the database, further comprising;
detecting a parent conversation ID in the received message;
updating, if a conversation ID identical to the parent conversation ID is included in the database, a conversation tree by adding the active conversation ID as a child conversation ID of the conversation ID identical to the parent conversation ID; and
generating a new conversation view corresponding to the active conversation ID and displaying the received message in the new conversation view.

5. The method of claim 4, further comprising copying a conversation tree of the parent conversation ID and the active conversation ID and storing the conversation tree in the database, if the conversation ID identical to the parent conversation ID is not included in the database.

6. The method of claim 1, further comprising:
writing a message, by the communication terminal, according to user input;
allocating, if the written message is for an initial conversation, a new first conversation ID to the initial conversation and an initial conversation group including the communication terminal and a receiving communication terminal of the written message as participating terminals; and
transmitting the written message by including the first conversation ID as an active conversation ID in the written message.

7. The method of claim 6, wherein if the written message is a successive message related to an existing conversation, further comprising:
detecting a conversation ID allocated to a conversation group having a participating terminal list identical to a terminal list including the communication terminal and the receiving communication terminal in a database that stores a conversation ID allocated to each conversation and a correlation between conversation IDs in a tree structure; and
transmitting the written message by including the detected conversation ID as the active conversation ID in the written message.

8. The method of claim 7, wherein the written message further includes one or more parent conversation IDs related to the active conversation ID, wherein if the written message is the successive message, further comprising:
comparing a participating terminal list of a conversation corresponding to a latest received message with the terminal list;
allocating a new second conversation ID to a conversation group corresponding to the terminal list and setting the second conversation ID as a child conversation ID of a conversation ID of the conversation corresponding to the latest received message, if the participating terminal list of the conversation corresponding to the latest received message is different from the terminal list and the terminal list is configured only by excluding a terminal from the participating terminal list of the conversation corresponding to the latest received message; and
transmitting the written message by including the second conversation ID as the active conversation ID in the written message.

9. The method of claim 8, wherein if the participating terminal list of the conversation corresponding to the latest received message is different from the terminal list, a conversation ID corresponding to a participating terminal list identical to the terminal list is not included in the database, and the terminal list is configured only by adding a terminal to the participating terminal list of the conversation corresponding to the latest received message, further comprising:
detecting a conversation group having a participating terminal list most similar to the terminal list, hierarchically close to an active conversation group; and
transmitting the written message by including a conversation ID of the detected conversation group as the active conversation ID in the written message.

10. The method of claim 8, wherein if the participating terminal list of the conversation corresponding to the latest received message is different from the terminal list, a conversation ID corresponding to a participating terminal list identical to the terminal list is not included in the database, and the terminal list is configured by adding a terminal to and excluding a terminal from the participating terminal list of the conversation corresponding to the latest received message, further comprising:
detecting a conversation ID corresponding to participating terminal list most similar to a list including terminals of the participating terminal list and the added terminal, hierarchically close to an active conversation group; and
allocating a new third conversation ID to the conversation group corresponding to the terminal list and setting the third conversation ID as a child conversation ID of the detected conversation ID; and
transmitting the written message by including the third conversation ID as the active conversation ID in the written message.

11. An apparatus for providing, a conversation within a conversation group, conducted by exchanging messages among a plurality of terminals of the same conversation group at a communication terminal supporting a messaging service, the apparatus comprising:
a display; and
a message client for detecting an active conversation Identifier (ID) from a received message, the active conversation ID identifying a conversation related to the received message and a conversation group including terminals participating in the conversation, and displaying the received message in a conversation view corresponding to the active conversation ID on the display.

12. The apparatus of claim 11, wherein the message client displays the received message in the conversation view corresponding to the active conversation ID on the display, if a conversation ID identical to the active conversation ID is included in a database that stores conversation IDs allocated to respective conversations and a correlation between the conversation IDs in a tree structure.

13. The apparatus of claim 12, wherein the message client generates a new conversation view corresponding to the active conversation ID and displays the received message in the new conversation view on the display, if the conversation ID identical to the active conversation ID is not included in the database and the received message does not include a parent conversation ID.

14. The apparatus of claim 12, wherein if the conversation ID identical to the active conversation ID is not included in the database, the message client detects a parent conversation ID in the received message, and if a conversation ID identical to the parent conversation ID is included in the database, and the message client updates a conversation tree by adding the active conversation ID as a child conversation ID of the conversation ID identical to the parent conversation ID, generates a new conversation view corresponding to the active conversation ID, and displays the received message in the new conversation view on the display.

15. The apparatus of claim 14, wherein if the conversation ID identical to the parent conversation ID is not included in the database, the message client copies a conversation tree of the parent conversation ID and the active conversation ID and stores the conversation tree in the database.

16. The apparatus of claim 11, wherein the message client writes a message according to user input, allocates, if the written message is for an initial conversation, a new first conversation ID to the initial conversation and an initial conversation group including the communication terminal and a receiving communication terminal of the written message as participating terminals, and transmits the written message by including the first conversation ID as an active conversation ID in the written message.

17. The apparatus of claim 16, wherein if the written message is a successive message related to an existing conversation, the message client detects a conversation ID allocated to a conversation group having a participating terminal list identical to a terminal list including the communication terminal and the receiving communication terminal in a database that stores a conversation ID allocated to each conversation and a correlation between conversation IDs in a tree structure, and transmits the written message by including the detected conversation ID as the active conversation ID in the written message.

18. The apparatus of claim 17, wherein the written message further includes one or more parent conversation IDs related to the active conversation ID, wherein if the written message is the successive message, the message client compares a participating terminal list of a conversation corresponding to a latest received message with the terminal list, and if the participating terminal list of the conversation corresponding to the latest received message is different from the terminal list and the terminal list is configured only by excluding a terminal from the participating terminal list of the conversation corresponding to the latest received message, the message client allocates a new second conversation ID to a conversation group corresponding to the terminal list, sets the second conversation ID as a child conversation ID of a conversation ID of the conversation corresponding to the latest received message, and transmits the written message by including the second conversation ID as the active conversation ID in the written message.

19. The apparatus of claim 18, wherein if the participating terminal list of the conversation corresponding to the latest received message is different from the terminal list, a conversation ID corresponding to a participating terminal list identical to the terminal list is not included in the database, and the terminal list is configured only by adding a terminal to the participating terminal list of the conversation corresponding to the latest received message, the message client detects a conversation group having a participating terminal list most similar to the terminal list, hierarchically close to an active conversation group, and transmits the written message by including a conversation ID of the detected conversation group as the active conversation ID in the written message.

20. The apparatus of claim 18, wherein if the participating terminal list of the conversation corresponding to the latest received message is different from the terminal list, a conversation ID corresponding to a participating terminal list identical to the terminal list is not included in the database, and the terminal list is configured by adding a terminal to and excluding a terminal from the participating terminal list of the conversation corresponding to the latest received message, the message client detects a conversation ID corresponding to participating terminal list most similar to a list including terminals of the participating terminal list and the added terminal, hierarchically close to an active conversation group, allocates a new third conversation ID to the conversation group corresponding to the terminal list and setting the third conversation ID as a child conversation ID of the detected conversation ID, and transmits the written message by including the third conversation ID as the active conversation ID in the written message.
